(19) United States
(12) Patent Application Publication
(10) Pub. No.: US 2026/0150866 A1
(43) Pub. Date: Jun. 4, 2026

(54) A METHOD FOR OBTAINING A PLANT-BASED FOOD INGREDIENT

(71) Applicant: Novozymes A/S, Bagsvaerd (DK)

(72) Inventors: Iannis SAMKIDIS, Aesch (CH); Jens Magnus EKLOF, Bagsvaerd (DK); Hanne Vang HENDRIKSEN, Bagsvaerd (DK)

(73) Assignee: Novozymes A/S, Bagsvaerd (DK)

(21) Appl. No.: 19/123,002

(22) PCT Filed: Oct. 25, 2023
(86) PCT No.: PCT/EP2023/079826

§ 371 Date: Apr. 21, 2025

(30) Foreign Application Priority Data
Oct. 28, 2022 (EP) 22204442.2

(51) Int. Cl. A23L 29/30; C12N 9/30; C12P 7/06; C12P 19/14

(52) U.S. Cl. CPC A23L 7/107; A23C 11/10; C12Y 302/01001

(57) ABSTRACT

The present invention relates to a method for obtaining a plant-based food ingredient for a dairy alternative food product, where plant material is hydrolyzed at a temperature between 25°-60° C. in the presence of a raw starch degrading alpha-amylase and optionally additional enzymes to obtain hydrolyzed plant material for use as a plant-based food ingredient for a dairy alternative food product.

### REFERENCE TO SEQUENCE LISTING

This application contains a Sequence Listing in computer readable form. The computer readable form is incorporated herein by reference.

### FIELD OF THE INVENTION

The present invention relates to use of enzymes having alpha-amylase activity for obtaining a hydrolyzed plant material.

### BACKGROUND OF THE INVENTION

The number of people pursuing a vegan, vegetarian, or non-dairy diet for health reasons has increased in recent years. Further, food products made from animals' milk, particularly cows, are increasingly recognized for their high environmental costs. These factors are leading to a greater demand for dairy alternative food products for many foods traditionally derived from milk, including milk, creamer, cheese, yogurt, and ice cream.

Dairy alternative food products are typically derived from high starch plant material, such as cereal grain, peas, or potatoes. In general, to convert the high-starch plant material to a dairy alternative food product or a food ingredient to be included in a dairy alternative food product, the starch must be hydrolysed. The conversion of the starch typically includes a gelatinisation step in which starch granules are dissolved to form a viscous suspension, a liquefaction step where the starch is partially hydrolysed with a concomitant loss in viscosity, and optionally followed by a saccharification step which involves the production of glucose and maltose by further hydrolysis.

Gelatinization is normally attained by heating, whereas liquefaction and possible saccharification often involve the use of enzymes. Typically, since high temperature is preferably used for the gelatinization, the liquefaction is also performed at high temperature. In that case, gelatinization and liquefaction are performed at a high temperature for an extended period of time, after which the plant material is rapidly cooled and then saccharification is performed as a second step at a lower temperature.

Holding the starch at a high temperature for an extended period of time and then rapidly cooling the mixture is an energy-intensive process. There is a need to reduce energy consumption, both because energy costs are rising globally and because consumers and producers recognize increasing energy efficiency as beneficial to the environment.

It is an object of the present invention to identify improved, energy-efficient processes for production of a hydrolyzed plant-based food ingredient for the production of a dairy alternative food product. Temp

### Temp

### SUMMARY OF THE INVENTION

The present invention relates to methods for obtaining a food ingredient for the production of dairy alternative food products, where the food ingredient is obtained from a slurry of plant material in water, where a raw starch degrading alpha amylase and optionally additional enzymes are added to the slurry which is held at a temperature between 25-60° C. to allow for hydrolysis of the plant material. The hydrolyzed plant material is a food ingredient for dairy alternative foods. Because hydrolysis occurs at a temperature between 25-60° C., this method is an improved, more energy-efficient process compared to known methods in the art which use a higher temperature for enzymatic hydrolysis.

In some methods of the invention, the hydrolyzed plant material is then separated into solid and liquid streams, and the liquid stream is harvested as a plant-based food ingredient for dairy alternative food products. The enzymes may then be inactivated, for example by heat treatment or UHT treatment of either the liquid stream or after the liquid stream is further processed.

The enzymes added to the slurry include a raw starch degrading alpha amylase. The raw starch degrading alpha amylase can be a GH13 family amylase and may also have a carbohydrate binding module (CBM) that binds preferentially to starch. This CBM may be a CBM20, 21, 25, 26, 34, 41, 45, 48, 53, 68, 69, 74, 82, or 83.

Additional enzymes may also be added to the slurry. The additional enzymes may also be raw starch degrading enzymes. The additional enzymes may include a glucoamylase, maltogenic amylase, beta-amylase, protease, hemicellulase, cellulase, pectolytic enzyme, glucosidase, glucanase, xylanase, arabinofuranosidase, pullulanase, and/or lipase, or any combination thereof.

The methods of the invention include a method for obtaining a plant-based food ingredient for a dairy alternative food product, comprising obtaining a slurry of heat-treated oat material and water, holding the slurry at a temperature between 25-60° C. in the presence of a raw starch degrading alpha amylase and a beta-glucanase, allowing the enzymes to hydrolyze the oat material for a period of time, separating the hydrolyzed oat material into solid and liquid streams, and finally harvesting the liquid stream as a plant-based food ingredient for a dairy alternative food product. The enzymes may be inactivated before or after the hydrolyzed oat material is separated into solid and liquid streams. In some embodiments, the enzymes are inactivated in the harvested liquid stream. The dairy alternative food product may be a beverage, yogurt, cheese, creamer, ice cream, or any other dairy alterative food product known in the art.

### DETAILED DESCRIPTION OF THE INVENTION

In accordance with this detailed description, the following definitions apply. Note that the singular forms “a,” “an,” and “the” include plural references unless the context clearly dictates otherwise.

As used herein, the terms “drink”, and “beverage” are used interchangeably and have the same meaning.

Unless defined otherwise or clearly indicated by context, all percentages are percentage by weight (percent w/w or “% (w/w)”).

The term “plant-based food ingredient” refers to a plant-based composition which may be combined with additional food ingredients to produce a food product. The plant-based food ingredient and the food product comprising the plant-based food ingredient can be ingested by humans or animals, including domesticated animals such as companion animals. In some embodiments, the plant-based food ingredient may be combined with additional food ingredients to produce a dairy alternative food product. The additional food ingredients may be any food ingredient deemed useful by a practitioner of skill in the art. The additional food ingredient may be a solid or liquid. The additional food ingredient may or may not be plant-based. In some embodiments, the additional food ingredient is water.

The term “dairy alternative food product” refers to a food product which can be used as a substitute for a dairy food product. A dairy alternative food product is plant-based and does not contain milk-derived food ingredients. Dairy alternative food products include plant-based beverages, creamer, cheese, ice cream, yogurt, and any other dairy alternative food product known in the art.

In some embodiments, the plant-based food ingredient may be directly combined with additional food ingredients to produce a dairy alternative beverage that is ready to drink. Examples of a dairy alternative beverage include an oat beverage, rice beverage, barley beverage, potato beverage, pea beverage, sesame beverage, almond beverage, hemp beverage, tiger nut beverage, or a beverage comprising any combination thereof.

In some embodiments, the plant-based food ingredient may be used as a substrate for fermentation to produce a dairy alternative beverage, such as buttermilk, or to produce a dairy alternative yogurt.

In some embodiments, the plant-based food ingredient may be further processed. Further processing may include water removal. In some embodiments, water removal will concentrate the products of hydrolysis, namely the released sugars. In some embodiments, water removal will increase the viscosity of the plant-based food ingredient.

In some embodiments, the plant-based food ingredient may optionally be further processed and combined with additional food ingredients to produce a dairy alternative ice cream. In some embodiments, the plant-based food ingredient may optionally be further processed and combined with additional food ingredients to produce a dairy alternative cheese.

The plant-based food ingredient of the invention is derived from plant material, which is or is derived from the edible portions of a plant. In some embodiments, the plant material is derived from edible portions of a plant which are also high in starch. In some embodiments, the edible portion of the plant may be tubers, roots, stems, cobs, legumes, fruits, nuts, or seeds. In some embodiments, the plant is a cereal and the plant material is or is derived from the cereal grain, also referred to as the whole grain. In further embodiments, the cereal grain may be from corn, rice, barley, wheat, buckwheat, millet, milo, quinoa, oat, or rye. In some embodiments, the plant material is or is derived from a tuber or root (including rhizomes), such as a potato, sweet potato, cassava, tiger nut (chufa nut), canna, or tapioca. In some embodiments, the plant material is or is derived from a fruit, such as banana, jack fruit, or bread fruit. In some embodiments, the plant material is or is derived from a nut, such as almond, macadamia, or cashew. In some embodiments, the plant material is or is derived from a hemp, sago, pea, or bean plant.

In some embodiments, the plant material is heat treated. In some embodiments, the plant material is dehydrated. In some embodiments, the plant material is de-hulled, ground, wet-milled, and/or dry milled. In some embodiments, the plant material is corn flour, rice flour, barley flour, wheat flour, buckwheat flour, millet flour, quinoa flour, oat flour, rye flour, potato flour, sweet potato flour, cassava flour, tiger nut flour, tapioca flour, hemp flour, sesame flour, nut flour (such as cashew, macadamia, or almond flour), pea flour, bean flour, de-hulled oats, de-hulled barley, de-hulled wheat, de-hulled peas, de-hulled beans, or a combination or any thereof. In some embodiments, the plant material is smashed or ground to produce a paste.

In some embodiments, the plant material is oat material. In further embodiments, the oat material is oat flour, oat flakes, oat bran, de-hulled oats, or a combination thereof. In still further embodiments, the oat material may be oat flour such as heat-treated oat flour, or it may be milled oat kernels such as de-hulled and heat-treated oat kernels which have been wet-milled, or it may be any other oat material known in the art. In some embodiments, the oat material is heat-treated oat flour, oat flakes, oat bran, or any combination thereof.

In the methods of the invention, the plant material is suspended in water to produce a slurry, where the ratio of plant material to water is 1:3 to 1:8 (w/w). In some embodiments, the ratio of plant material to water is 1:4 to 1:16. In some embodiments, the ratio of plant material to water is 1:1 to 1:4.

In the methods of the invention, a raw starch degrading alpha-amylase and optionally additional enzymes are added to the slurry and the mixture is held at a temperature between 25-60° C., so that the plant material is hydrolyzed by the enzymes to produce a hydrolyzed plant material. In some embodiments, slurry is held at a temperature below the gelatinization temperature of the starch in the slurry.

A “raw starch degrading enzyme” (also known as a raw starch hydrolyzing enzyme) as used herein refers to an enzyme that can directly degrade raw starch granules below the gelatinization temperature of starch. The gelatinization temperature of starch can range from 51° C. to 78° C. as the gelatinization initiation temperature can vary from about 51° C. to 68° C. When barley flour is used, the raw starch degrading alpha-amylase can directly degrade raw starch when the gelatinization temperature is about 53° C. to 63° C. When oat flour is used, the raw starch degrading alpha-amylase can directly degrade raw starch when the gelatinization temperature is about 55° C. to 62° C. A raw starch degrading alpha-amylase is a raw starch degrading enzyme.

In one embodiment, the raw starch degrading enzyme is defined as an enzyme that has a raw starch degrading index of at least 0.2, at least 0.3, at least, 0.4, at least 0.5, at least 0.6, at least 0.7, at least 0.8, at least 0.9, at least 1, at least 1.1, at least 1.2, at least 1.3, at least 1.4, at least 1.5, at least 1.6, at least 1.7, at least 1.8, at least 1.9, at least 2, wherein the raw degrading index is a ratio of activity to degrade raw starch to activity to degrade gelatinized starch (Ra/Ga). Preferably, the raw starch degrading enzyme is defined as an enzyme that has a raw starch degrading index of higher than 1. The activity on gelatinized starch is measured by measuring the release of glucose produced by the enzyme on a 2% gelatinized (e.g., corn) starch reaction mixture. The activity is measured by the release of reducing sugars produced in 4 mol per hour per mg of pure active enzyme. The same assay can then be used to measure the activity of the enzyme on raw starch, but substituting the 2% gelatinized (e.g., corn) starch by 2% of raw (e.g., corn) starch. In both assays, the temperature is 40° C., the same pH and buffer solution is used, and the incubation time is 6 hours.

Raw starch degrading enzymes are ubiquitous and produced by plants, animals, and microorganisms, such as fungal, bacterial and yeast raw starch degrading enzymes. In some embodiments, a raw starch degrading enzyme is a glucoamylase. In other embodiments, the raw starch degrading enzyme is an alpha-amylase, also referred to as a raw starch degrading alpha-amylase. In some embodiments, raw starch degrading enzymes refer to alpha-amylases, glucoamylases, or a combination of one or more alpha-amylases and one or more glucoamylases. Sources of raw starch degrading enzymes include enzymes obtained from Aspergillus spp. such as Aspergillus oryzae, Aspergillus niger and Aspergillus kawachii alpha-amylases. Examples of such raw starch degrading enzymes include the raw starch degrading enzymes described in WO 2005/003311, WO 2006/0692, WO 2006/060289 and WO 2004/080923.

In some embodiments, the raw starch degrading alpha-amylase is an acid alpha-amylase. An “acid alpha-amylase” is an alpha-amylase (4-α-D-glucan glucanohydrolase, E.C. 3.2.1.1) which when added in an effective amount has activity at a pH in the range of 3.0 to 7.0, preferably from 3.5 to 6.0, or more preferably from 4.0-5.0. A source of a raw starch degrading acid alpha-amylase is the acid alpha amylase from Aspergillus niger disclosed as “AMYA_ASPNG” in the Swiss-prot/TeEMBL database under the primary accession no. P56271 and described in more detail in WO 1989/01969 (Example 3). The Aspergillus niger acid alpha-amylase is also shown as SEQ ID NO: 1 in WO 2004/080923 (Novozymes A/S) which is hereby incorporated by reference. A suitable commercially available acid fungal alpha-amylase derived from Aspergillus niger is the product SP288 (SEQ ID NO:1 of U.S: U.S. Pat. No. 7,244,597; available from Novozymes A/S). Other sources of acid alpha-amylases include those derived from a strain of the genera Rhizomucor and Meripilus, such as a strain of Rhizomucor pusillus (WO 2004/055178) or Meripilus giganteus. In yet another embodiment, the acid alpha-amylase is derived from Aspergillus kawachii and is disclosed by Kaneko et al. J. Ferment. Bioeng. 81:292-298 (1996) “Molecular-cloning and determination of the nucleotide-sequence of a gene encoding an acid-stable alpha-amylase from Aspergillus kawachii”; and further as EMBL: #AB008370.

In some embodiments, the raw starch degrading alpha amylase possesses a carbohydrate binding module (CBM) which binds to starch. In some embodiments, the CBM binds preferentially to starch, particularly to thermally untreated, granular starch. Such a CBM may also be referred to as a starch binding domain (SBD). SBDs are known to be in 15 CBM families, namely CBM20, 21, 25, 26, 34, 41, 45, 48, 53, 68, 69, 74, 82, and 83.

In some embodiments, the raw starch degrading alpha amylase may be a hybrid alpha-amylase comprising a starch-binding domain (SBD) and an alpha-amylase catalytic domain (CD). A hybrid alpha-amylase may also comprise an alpha-amylase catalytic domain (CD), a starch binding domain (SBD), and a linker connecting the CD and SBD, as is known in the art. In an embodiment the catalytic domain is derived from a strain of Aspergillus kawachii. Examples of hybrid alpha-amylases include the ones disclosed in WO 2005/003311, U.S. Patent Publication no. 2005/0054071 (Novozymes), and U.S. Pat. No. 7,326,548 (Novozymes) which is hereby incorporated by reference. Examples also include those enzymes disclosed in Table 1 to 5 of the examples in U.S. Pat. No. 7,326,548, and in U.S. Patent Publication no. 2005/0054071 (Table 3 on page 15), such as, an Aspergillus niger alpha-amylase catalytic domain (CD) with Aspergillus kawachii linker and starch binding domain (SBD).

Other acid alpha-amylase include the enzymes disclosed in WO 2004/020499 and WO 2006/069290 and the enzymes disclosed in WO 2006/066579 as SEQ ID NO:2 (hybrid A. niger alpha-amylase+CBM), SEQ ID NO:3, or SEQ ID NO:4 (JA 129). Hybrid alpha-amylase consisting of Rhizomucor pusillus alpha-amylase with Aspergillus niger glucoamylase linker and SBD disclosed as V039 in Table 5 in WO 2006/069290.

SEQ ID NOs: 1-4 are GH13 family raw starch degrading alpha-amylases. In some embodiments, the raw starch degrading alpha-amylase of the present invention is a GH13 family amylase. In some embodiments, the raw starch degrading alpha-amylase has an amino acid sequence which is at least 60%, at least 70%, at least 75%, at least 80%, at least 85%, at least 90%, at least 95%, at least 96%, at least 97%, at least 98%, or at least 99% identical to the amino acid sequence of SEQ ID NOs: 1, 2, 3, or 4. In some embodiments, the raw starch degrading alpha-amylase of the present invention has the amino acid sequence of SEQ ID NOs: 1, 2, 3, or 4.

The term “identity” is the relatedness between two amino acid sequences or between two nucleotide sequences. For purposes of the present invention, the degree of identity between two amino acid sequences is determined using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends in Genetics 16:276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labelled “longest identity” (obtained using the -nobrief option) is used as the percent identity and is calculated as follows:

(Identical Residues×100)/(Length of Alignment−Total Number of Gaps in Alignment)

The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a polyhistidine tract, an antigenic epitope, or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/Ile, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/Ile, Leu/Val, Ala/Glu, and Asp/Gly.

In some embodiments, the raw starch degrading alpha-amylase has at least 70% sequence identity, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or even 100% sequence identity to SEQ ID NO: 1.

In another embodiment, the raw starch degrading alpha-amylase has at least 70% sequence identity, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or even 100% sequence identity to SEQ ID NO: 2.

In another embodiment, the raw starch degrading alpha-amylase has at least 70% sequence identity, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or even 100% sequence identity to SEQ ID NO: 3.

In another embodiment, the raw starch degrading alpha-amylase has at least 70% sequence identity, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or even 100% sequence identity to SEQ ID NO: 4.

The raw starch degrading alpha-amylase may be added in the range of 500-25000 parts per million (ppm) based on the amount of plant material added. In some embodiments, 500-20000, 750-20000, 750-18000, 750-17000, 750-15000, 750-1000, 750-7500, or 1000-5000 ppm raw starch degrading alpha-amylase may be added to the slurry. In some embodiments, 750-2500 or 1000-1500 ppm raw starch degrading alpha amylase may be added to the slurry.

The products of hydrolysis by the raw starch degrading alpha-amylase comprise malto-oligosaccharides (MOS). Malto-oligosaccharides comprise a glucose molecule with one or more branched bonds (alpha-1,4) with a typical degree of polymerization (DP) of 2-9. MOS can be indigestible oligosaccharides with a short chain length (2-10), which may have a prebiotic effect that enhances the growth of beneficial bacteria in the human gut (see for example Jang et al., 2020, Molecules 25:5201, doi: 10.3390/molecules25215201). In some embodiments, the dairy alternative food product comprising the plant-derived food ingredient of the invention may have a prebiotic effect when consumed.

In some embodiments of the invention, one or more additional enzyme(s) is added to the slurry to allow for the hydrolysis of the plant material. The additional enzymes may be a glucoamylase, maltogenic amylase, beta-amylase, protease, hemicellulase, cellulase, pectolytic enzyme, glucosidase, glucanase, xylanase, arabinofuranosidase, pullulanase, and/or lipase, or any combination thereof. The additional enzyme(s) may be of any origin, including mammalian, plant, and microbial (bacterial, yeast or fungal) origin.

In some embodiments, the additional enzyme is a glucoamylase (also known as amyloglucosidase). One Glucoamylase Unit (AGU) is defined as the amount of enzyme, which hydrolyzes 1 micromole maltose per minute under the standard conditions 37° C., pH 4.3, substrate: maltose 23.2 mM, buffer: acetate 0.1 M, reaction time 5 minutes. In some embodiments, the glucoamylase may be added at a concentration of 50-1000 AGU/kg plant material.

In some embodiments, the additional enzyme is a maltogenic amylase. The maltogenic alpha-amylase (EC 3.2.1.133) may be from Bacillus. A maltogenic alpha-amylase from B. stearothermophilus strain NCIB 11837 is commercially available from Novozymes A/S under the tradename Novamyl®. The maltogenic alpha-amylase may also be a variant of the maltogenic alpha-amylase from B. stearothermophilus as disclosed in, e.g., WO1999/043794; WO2006/032281; or WO2008/148845, e.g., Novamyl® 3D.

In some embodiments, the additional enzyme is a xylanase. The xylanase may be of microbial origin, e.g., derived from a bacterium or fungus, such as a strain of Aspergillus, in particular of A. aculeatus, A. niger, A. awamori, or A. tubigensis, from a strain of Trichoderma, e.g. T. reesei, or from a strain of Humicola, e.g., H. insolens. In some embodiments, the xylanase is derived from a strain of T. reeseii. Suitable commercially available xylanase preparations for use in the present invention include PANZEA BG, PENTOPAN MONO BG and PENTOPAN 500 BG (available from Novozymes A/S), GRINDAMYL POWERBAKE (available from Danisco), and BAKEZYME BXP 5000 and BAKEZYME BXP 5001 (available from DSM).

In some embodiments, the additional enzyme is a protease. The protease may be from Bacillus, e.g., B. amyloliquefaciens. A suitable protease may be Neutrase® available from Novozymes A/S.

In some embodiments, the additional enzyme is a beta-glucanase. A beta-glucanase may only have beta-glucanase activity or may have other enzymatic activities as well. In some embodiments, the beta-glucanase has at least 70% sequence identity, at least 75%, at least 80%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, or even 100% sequence identity to SEQ ID NO: 5.

In some embodiments, the enzyme having beta-glucanase activity may be a preparation of an endo-alpha-amylase obtained from Bacillus, such as for example from Bacillus amyloliquefaciens, which has beta-glucanase side activity. In some embodiments, the enzyme having beta-glucanase activity may be in a cellulolytic enzyme preparation. In further embodiments, the cellulolytic enzyme preparation may be obtained from Trichoderma reesei. In other embodiments, the beta-glucanase is obtained from Aspergillus niger. Examples of enzyme preparations having beta-glucanase activity include BAN®, Celluclast®, or Ultraflo® Prime, each available from Novozymes A/S. These enzyme preparations are considered to comprise a beta-glucanase. Ultraflo® Prime comprises a beta-glucanase and a xylanase.

In some embodiments, the beta-glucanase may be added in parts per million (ppm) based on the amount of plant material used. In some embodiments, 1-2500 ppm beta-glucanase may be added to the slurry. In some embodiments, 5-2500, 20-2500, 50-2500, 50-2000, 50-1800, 50-1500, 50-1000, 50-750, 75-500, or 75-300 ppm beta-glucanase may be added to the slurry. In some embodiments, 1-200, 1-150, or 1-100 ppm beta-glucanase may be added to the slurry. In some embodiments, 1-200, 1-100, 1-50, 1-25, 1-20, 1-15, 1-10, 1, 2, 3, 4, 5, 6, 7, 8, 9, or 10 ppm beta-glucanase may be added to the slurry.

In some embodiments, a raw starch degrading alpha-amylase and a beta-glucanase are added to the slurry. In further embodiments, the slurry comprises oat material and water. In still further embodiments, the slurry comprises oat flour and water. In still further embodiments, the slurry comprises heat-treated oat flour and water. In some embodiments, the raw starch degrading alpha-amylase is added at 500-25000 ppm, and the beta-glucanase is added at 1-2500 ppm. In some embodiments, the raw starch degrading alpha-amylase is added at 750-15000 ppm and the beta-glucanase is added at 1-500 ppm. In some embodiments, the raw starch degrading alpha-amylase is added at 1000-7000 ppm and the beta-glucanase is added at 1-300 ppm. In some embodiments, the raw starch degrading alpha-amylase is added at 1000-5000 ppm and the beta-glucanase is added at 1-150 ppm. In some embodiments, the raw starch degrading alpha-amylase is added at 1000-1500 ppm and the beta-glucanase is added at 1-100 ppm.

The raw starch degrading alpha-amylase and optionally additional enzyme(s) may be provided in any suitable form, such as in the form of a liquid, in particular a stabilized liquid, or the enzyme(s) may be added as a substantially dry powder or granulate. Granulates may be produced, e.g., as disclosed in U.S. Pat. Nos. 4,106,991 and 4,661,452. Liquid enzyme preparations may, for instance, be stabilized by adding a sugar or sugar alcohol or lactic acid according to established procedures. Other enzyme stabilizers are well-known in the art.

The enzyme combination may be added to the slurry comprising the plant material in any suitable manner, such as individual components (separate or sequential addition of the enzymes) or addition of the enzymes together in one step or one composition, or any combination thereof.

The slurry is held at a temperature between 25-60° C. to allow for hydrolysis of the plant material. In some embodiments, the slurry is held at a temperature between 25-55° C., 30-55° C., 35-55° C., 40-60° C., 30-50° C., 40-55° C., 45-55° C., or 50-55° C. In further embodiments, the slurry is held at a temperature of about 25° C., about 30° C., about 35° C., about 40° C., about 45° C., about 50° C., about 55° C., or about 60° C.

In some embodiments, the slurry with the added enzymes is held at a temperature between 25-60° C. for at least 10 minutes to allow for enzymatic hydrolysis of the plant material. In some embodiments, the slurry is held for about 10, about 15, about 20, about 25, about 30, about 60, about 120, about 180, about 240 or at least about 240 minutes to allow for enzymatic hydrolysis of the plant material. In some embodiments, the slurry is held for at least about 10, 30, 60, or 90 minutes. In some embodiments, the slurry is held for 30 minutes. In some embodiments, the slurry is held for 60 minutes. In some embodiments, the slurry is held for 90 minutes. A person of skill in the art will recognize that a relationship exists between the enzyme dosage, the incubation temperature, and the amount of time allowed for enzymatic hydrolysis, such that a higher dose of enzyme will allow for a shorter incubation time, a lower dose of enzyme may achieve the same level of hydrolysis in a longer incubation time, and a higher incubation temperature may allow for a lower dose of enzyme and/or a shorter incubation time.

After treatment with the raw starch degrading alpha-amylase and optionally additional enzymes, the enzyme(s) may be inactivated. The enzymes may be inactivated at any step after hydrolysis. In some embodiments, the enzymes are inactivated before or after the hydrolyzed plant material has been separated into solid and liquid streams. In other embodiments, the enzymes are inactivated after additional food ingredients have been added to the harvested liquid stream.

In some embodiments, the enzymes are inactivated by a heat treatment. In some embodiments, the heat treatment is a temperature between 85-95° C. for 5-30 minutes. In further embodiments, the heat treatment is a temperature between 85-95° C. for 10-15 minutes. In some embodiments, the heat treatment is 95° C. for 5, 10, 15, 20, 25, or 30 minutes. In some embodiments, the heat treatment is a temperature between 85-95° C. for one minute or less. In some embodiments, the heat treatment is a temperature between 85-95° C. for 10, 15, 20, 25, 30, 35, 40, 45, 50, 55, or 60 seconds.

In some embodiments, the enzymes are inactivated by an Ultra High Temperature (UHT) treatment. The UHT treatment may be direct or indirect. In some embodiments, the UHT treatment is a temperature between 135-154° C. for 1-10 seconds. In further embodiments, the UHT treatment is a temperature between 140-150° C. for 3, 4, 5, 6, 7, 8, 9, or 10 seconds. In further embodiments, the UHT treatment is a temperature between 140-145° C. for 3, 4, 5, 6, 7, 8, 9, or 10 seconds. In some embodiments, the UHT treatment is 143° C. for 4, 5, 6, 7, or 8 seconds.

Following enzymatic hydrolysis, hydrolyzed plant material is produced. The hydrolyzed plant material may also be referred to as plant hydrolysate, for example oat hydrolysate. After enzyme inactivation, the hydrolyzed plant material may be cooled. The hydrolyzed plant material may be separated into a solid and a liquid stream, for example by centrifugation. Centrifugation may occur in a decanter centrifuge. Following centrifugation, the liquid stream may be harvested or collected and used as a food ingredient for dairy alternative foods. The liquid stream may still comprise some solid matter. In some embodiments, the liquid stream comprises 1-80% solids. In further embodiments, the liquid stream comprises 1-10%, 5-20%, 10-25%, 20-35%, 25-40%, 30-45%, 35-50%, 40-55%, 45-60%, 50-65%, 55-70%, 60-75%, or 65-80% solids. In some embodiments, the liquid stream comprises 10-15% solids. The solids in the liquid stream, also referred to as the “total solids” may be measured using methods well-known in the art. For example, a sample of the liquid stream may be dried, typically with heat, and then the remaining solids may be weighed.

The liquid stream, which may still be referred to as the plant hydrolysate, comprises solids and sugars which are useful for the production of a dairy alternative food product. The viscosity of the liquid stream also affects its usefulness for the production of a dairy alternative food product. The viscosity is determined in part by the beta-glucan content, where a higher beta-glucan content increases viscosity. A plant hydrolysate which has very high viscosity may be difficult to process in industrial manufacturing. Additionally, a plant hydrolysate with very high viscosity may be difficult to use as a food ingredient for the production of a dairy alterative food product, particularly for the production of a dairy alternative beverage. The viscosity of the plant hydrolysate also plays a role in its usefulness as food ingredient in a dairy alternative food product. Certain food products have preferences for certain levels of viscosity. For example, a dairy alternative oat beverage typically has a viscosity similar to that of low-fat or skim milk.

In some embodiments, the liquid stream is further processed to remove water, or concentrated. Concentration increases the relative amount of solids in the concentrated liquid stream. Concentration may occur by evaporation of the water in the liquid stream. In some embodiments, the concentrated liquid stream comprises 10-95% solids. In further embodiments, the concentrated liquid stream comprises 10-20%, 20-30%, 30-40%, 40-50%, 50-60%, 60-70%, 70-80%, 80%-90%, or 90-95% solids. In some embodiments, water removal will increase the viscosity of the dairy alternative food product.

In some embodiments, the liquid stream is used directly as a plant-based food ingredient. The liquid stream may be referred to as “base”. Additional food ingredients may be added to the liquid stream to produce a dairy alternative food product. In some embodiments, the liquid stream is derived from oat hydrolysate, and may be referred to as “oat base”. In further embodiments, the oat base may be formulated using for example sodium chloride (NaCl), oil, and optionally flavouring agents. Such a formulation may be considered an dairy-alternative food product. The oat base may be homogenized before or after the addition of food ingredients.

The dairy-alternative food product may be UHT or ESL treated and aseptically packed. The final product may be sold as a plant-based beverage, which is a dairy-alternative food product.

Alternatively, the liquid stream, in some embodiments the oat base, may be further processed into other dairy alternative food products, such as a fermented plant-based product or a plant-based ice cream, or it may be used as an ingredient in a dairy alternative food product.

In some embodiments, the liquid stream is an oat base which is processed into an oat-based dairy alternative food product. In some embodiments, the food product is an oat-based beverage, oat-based creamer, oat-based yogurt, oat-based cheese, or oat-based ice cream.

The invention is further defined by the following numbered embodiments:

1. A method for obtaining a plant-based food ingredient for a dairy alternative food product, comprising:
(a) obtaining a slurry of plant material in water; and
(b) providing a raw starch degrading alpha-amylase and optionally additional enzyme(s) to the slurry of step (a) and holding at a temperature between 25-60° C., to obtain a hydrolyzed plant material;
wherein the hydrolyzed plant material is a plant-based food ingredient for a dairy alternative food product.

2. The method of embodiment 1, further comprising
(c) separating the hydrolyzed plant material into solid and liquid streams;
(d) harvesting the liquid stream as a plant-based food ingredient for dairy alternative foods; and
(e) optionally inactivating the enzyme before or after step (c) or (d).

3. The method of any one of embodiments 1 or 2, wherein the raw starch degrading alpha-amylase is a GH13 family amylase.

4. The method of embodiment 3, wherein the GH13 family amylase comprises a carbohydrate binding module (CBM) which binds preferentially to starch.

5. The method of embodiment 4, wherein the CBM is CBM20, 21, 25, 26, 34, 41, 45, 48, 53, 68, 69, 74, 82, or 83.

6. The method of any one of the preceding embodiments, wherein the raw starch degrading alpha-amylase comprises an amino acid sequence at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% identical to SEQ ID NO: 1, 2, 3, or 4.

7. The method of any one of the preceding embodiments, wherein the additional enzyme is a glucoamylase, maltogenic amylase, beta-amylase, protease, hemicellulase, cellulase, pectolytic enzyme, glucosidase, glucanase, xylanase, arabinofuranosidase, pullulanase, and/or lipase, or any combination thereof.

8. The method of any one of the preceding embodiments, wherein the additional enzyme is a second raw starch degrading enzyme.

9. The method of any one of the preceding embodiments, wherein the additional enzyme is a beta-glucanase.

10. The method of any one of the preceding embodiments, wherein the additional enzyme is a xylanase.

11. The method of any one of the preceding embodiments, wherein the slurry of step (b) comprises a beta-glucanase and a xylanase.

12. The method of any one of the preceding embodiments, wherein the raw starch degrading alpha-amylase is added to the slurry at a dosage between 500-20000, 750-20000, 750-18000, 750-17000, 750-15000, 750-2500, 750-1000, 750-7500, 1000-5000, or 1000-1500 ppm.

13. The method of any one of embodiments 9, 11, or 12, wherein the beta-gluancase is added to the slurry at a dosage between 1-200, 1-150, or 1-100 ppm.

14. The method of any one of the preceding embodiments, wherein the temperature of step (b) is a temperature between 25-55° C., 30-55° C., 35-55° C., 40-60° C., 30-50° C., or 40-55° C.

15. The method of any of the preceding embodiments, wherein the enzyme is inactivated by a heat treatment or an Ultra-High Temperature (UHT) treatment.

16. The method of embodiment 15, wherein the UHT treatment is at a temperature between 140-145° C. for 2-8 seconds.

17. The method of any one of the preceding embodiments, wherein the plant material is derived from tubers, roots, stems, legumes, fruits, nuts, seeds, or whole grains.

18. The method of any one of the preceding embodiments, wherein the plant material is derived from corn, rice, barley, wheat, quinoa, oat, rye, buckwheat, milo, millet, sago, cassava, tapioca, potatoes, sweet potatoes, peas, beans, almond, cashew, macadamia, banana, jack fruit, and/or bread fruit.

19. The method of any one of the preceding embodiments, wherein the plant material is a cereal flour or de-hulled grains, including corn flour, rice flour, barley flour, buckwheat flour, wheat flour, millet flour, quinoa flour, oat flour, rye flour, or a mixture thereof.

20. The method of any one of the preceding embodiments, wherein the plant material is oat material, such as oat flour, oat flakes, oat bran, groats, or any combination thereof.

21. The method of any one of the preceding embodiments, wherein the dairy alternative food product is a plant-based beverage, plant-based ice cream, plant-based creamer, plant-based yogurt, or plant-based cheese.

22. A plant-based food ingredient for a dairy alternative food product produced by the method of any one of the preceding embodiments.

23. The method of any one of the preceding embodiments, wherein the plant-based food ingredient is combined with additional food ingredients to produce a dairy alternative food product.

24. A method for obtaining an oat hydrolysate food ingredient for a dairy alternative food product, comprising
(a) obtaining a slurry of oat material in water;
(b) providing a raw starch degrading alpha-amylase and a beta-glucanase to the slurry of step (a) and holding at a temperature between 25-60° C., 25-55° C., 45-55° C., or 50-55° C. to obtain an oat hydrolysate; and
(c) optionally inactivating the enzymes;
wherein the oat hydrolysate is a plant-based food ingredient for dairy alternative foods.

25. The method of embodiment 24, further comprising
(d) separating the oat hydrolysate into solid and liquid streams; and
(e) harvesting the liquid stream as an oat-based food ingredient for a dairy alternative food product.

26. A method for obtaining an oat hydrolysate food ingredient for a dairy alternative food product, comprising
(a) obtaining a slurry of oat material in water;
(b) holding the slurry of step (a) at a temperature between 25-60° C. and adding a raw starch degrading alpha-amylase and a beta-glucanase to obtain an oat hydrolysate;
(c) separating the oat hydrolysate into solid and liquid streams;
(d) harvesting the liquid stream; and
(e) optionally inactivating the enzymes before or after step (c) or (d);
wherein the harvested liquid stream is an oat hydrolysate food ingredient for a dairy alternative food product.

27. The method of any one of embodiments 24-26, wherein the raw starch degrading alpha-amylase comprises an amino acid sequence at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% identical to SEQ ID NO: 1, 2, 3, or 4.

28. The method of any one of embodiments 24-27, wherein the temperature of step (b) is between 25-55° C., 30-55° C., 35-55° C., 40-60° C., 30-50° C., 40-55° C., 45-55° C., or 50-55° C.

29. The method of any one of embodiments 24-28, wherein the slurry of step (b) additionally comprises a xylanase.

30. The method of any one of embodiments 24-29, wherein the raw starch degrading alpha-amylase is added to the slurry at a dosage between 500-20000, 750-20000, 750-18000, 750-17000, 750-15000, 750-2500, 750-1000, 750-7500, 1000-5000, or 1000-1500 ppm.

31. The method of any one of embodiments 24-30, wherein the beta-gluancase is added to the slurry at a dosage between 1-200, 1-150, or 1-100 ppm.

32. A plant-based food ingredient produced by the method of any one of the proceeding embodiments, wherein the plant-based food ingredient has a prebiotic effect when consumed.

33. A dairy alternative food product comprising the plant-based food ingredient of embodiment 32, wherein the dairy alternative food product has a prebiotic effect when consumed.

34. An oat hydrolysate food ingredient produced by the method of any one of embodiments 24-31, wherein the oat hydrolysate food ingredient has a prebiotic effect when consumed.

35. A dairy alternative food product comprising the oat hydrolysate food ingredient of embodiment 34, wherein the dairy alternative food product has a prebiotic effect when consumed.

36. Use of a raw starch degrading alpha-amylase in the hydrolysis of plant-based material for the production of a plant-based food ingredient for a dairy alternative food product.

37. Use according to embodiment 36, wherein the plant-based material is oat material, such as oat flour, oat flakes, oat bran, groats, or any combination thereof.

38. Use of a raw starch degrading alpha-amylase and a beta-glucanase in the hydrolysis of oat material for the production of a plant-based food ingredient for a dairy alternative food product.

The invention described and claimed herein is not to be limited in scope by the specific embodiments herein disclosed, since these embodiments are intended as illustrations of several aspects of the invention. Any equivalent embodiments are intended to be within the scope of this invention as well as combinations of one or more of the embodiments.

Various references are cited herein, the disclosures of which are incorporated by reference in their entireties. The present invention is further described by the following examples which should not be construed as limiting the scope of the invention.

### EXAMPLES

### Example 1: Preparation of a Plant-Based Food Ingredient Using the Raw Starch Degrading Alpha-Amylase of SEQ ID NO: 1

1000 ppm (on oat flour basis) of the amylase encoded by SEQ ID NO: 1 was added to 650 L of water at 63° C. together with 50 ppm beta-glucanase (Ultraflo® Prime, Novozymes A/S, Denmark) and mixed with 200 Kg oat flour. Another 150 L water was added and the final temperature reached was 62° C. After 10 minutes another 50 ppm beta-glucanase (Ultraflo® Prime, Novozymes A/S, Denmark) was added and the slurry was held at 62° C. for 60 minutes to allow for hydrolysis.

Following hydrolysis, the hydrolyzed slurry was processed in a decanter at 60° C. and the separated liquid stream was cooled to 10° C. The liquid stream is a plant-based food ingredient, now also referred to as an oat concentrate base.

The oat concentrate base was diluted with water (44% w/w) and salt (0.08% w/w) and rapeseed oil (0.8% w/w) were then added. The resulting oat beverage was UHT treated using methods known in the art and aseptically packed. The oat beverage was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Tables 1 and 2 below. Table 1 provides the viscosity, total solids, and sugar content of the oat beverage. Table 2 shows the amounts of certain malto-oligosaccharides (MOS) present in oat beverage.

### Example 2: Preparation of a Plant-Based Food Ingredient Using the Raw Starch Degrading Alpha-Amylase of SEQ ID NO: 2

1500 ppm (on oat flour basis) of the amylase encoded by SEQ ID NO: 2 was added to 650 L of water at 63° C. together with 100 ppm beta-glucanase (Ultraflo® Prime, Novozymes A/S, Denmark) and mixed with 200 Kg oat flour. Another 150 L water was added and the final temperature reached was 60° C. The slurry was held at 60° C. for 60 minutes to allow for hydrolysis.

Following hydrolysis, the hydrolyzed slurry was processed in a decanter at 60° C. and the separated liquid stream was cooled to 10° C. The liquid stream is a plant-based food ingredient, now also referred to as an oat concentrate base.

The oat concentrate base was diluted with water (47.16% w/w) and salt (0.08% w/w) and rapeseed oil (0.8% w/w) were then added. The resulting oat beverage was UHT treated using methods known in the art and aseptically packed. The oat beverage was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Tables 1 and 2 below. Table 1 provides the viscosity, total solids, and sugar content of the oat beverage. Table 2 shows the amounts of certain malto-oligosaccharides (MOS) present in oat beverage.

TABLE 1
Viscosity and Released Sugars in Oat Beverage

| Amylase | | Beta | | | | | Total |
|---|---|---|---|---|---|---|---|
| (SEQ ID | Amylase | glucanase | | Total | Glucose | Maltose | sugars |
| NO.) | (ppm) | (ppm) | Viscosity | solids % | (g/100 g) | (g/100 g) | (g/100 g) |
| 1 | 1000 | 100 | 7.36 | 11.27 | 2.13 | 1.66 | 4.10 |
| 2 | 1500 | 100 | 3.32 | 10.28 | 1.99 | 2.08 | 4.22 |

TABLE 2
MOS in Oat Beverage

| Amylase | | | Total |
|---|---|---|---|
| (SEQ | Maltotriose | Maltotetraose | MOS |
| ID NO.) | (g/100 g) | (g/100 g) | (g/100 g) |
| 1 | 0.74 | 0.19 | 0.93 |
| 2 | 0.26 | 0.15 | 0.41 |

Tables 1 and 2 show that an oat beverage is obtained having a good viscosity and comprising suitable amounts of total solids, total sugars and MOS. These results show that the hydrolyzed oat material and the oat concentrate base can be a source for a plant-based food ingredient for a dairy alternative food product. The oat concentrate base produced here, where the oat has been hydrolyzed in one step at about 60° C., has similar viscosity and amounts of solids, sugars and MOS as an oat concentrate base where the oat has been hydrolyzed using a conventional method including gelatinization and liquefaction at high temperature followed by rapid cooling and saccharification.

### Example 3: Preparation of an Oat Hydrolysate Using the Raw Starch Degrading Alpha-Amylase of SEQ ID NO: 1

Heat-treated oat flour was mixed with water comprising enzyme in a ratio of 100 g oat flour to 600 g of water. Assays were performed using the amylase encoded by SEQ ID NO: 1 and a beta-glucanase (Ultraflo® Prime, Novozymes A/S, Denmark), or a standard method which comprises two different amylases, namely BAN® 480 L (Novozymes A/S, Denmark), supplied at the dosages stated in Tables 3 and 4, and also Fungamyl® 800 L (Novozymes A/S, Denmark), supplied at 1500 ppm for all samples comprising BAN® 480 L. The mixture of water, enzyme and oat flour was then heated to 25° C., 40° C., or 60° C. for 30 minutes to allow for liquefaction/hydrolysis, followed by inactivation of the enzymes by increasing the temperature to 95° C. for 15 minutes. After inactivation, the hydrolysates were cooled to 60° C. for centrifugation and centrifuged at a Relative Centrifugal Force of 1932×g using a Multifuge® 3 S-R (Kendro Heraeus, Hanau, Germany) to separate the solid and liquid phases. The liquid phase was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Table 3. Table 3 provides the viscosity, total solids, and sugar content of the oat hydrolysate. Amylase and beta glucanase amounts are provided in ppm on flour basis.

TABLE 3
Viscosity and Released Sugars in Oat Hydrolysate

| | | Beta | Hydrolysis | | | | | Total |
|---|---|---|---|---|---|---|---|---|
| | Amylase | glucanase | temperature | | Total | Glucose | Maltose | sugars |
| Amylase | (ppm) | (ppm) | (° C.) | Viscosity | solids (%) | (g/100 g) | (g/100 g) | (g/100 g) |
| | 0 | 0 | 60 | 3.1 | 0.78 | 0.00 | 0.01 | 0.36 |
| | 0 | 0 | 40 | 1.3 | 0.46 | 0.00 | 0.00 | 0.38 |
| | 0 | 0 | 25 | 1.2 | 0.41 | 0.01 | 0.00 | 0.37 |
| BAN ® | 2000 | 0 | 60 | 2.9 | 12.14 | 0.17 | 2.65 | 2.93 |
| 480 L | | | | | | | | |
| BAN ® | 2500 | 0 | 40 | 4.0 | 11.63 | 0.05 | 0.44 | 0.59 |
| 480 L | | | | | | | | |
| BAN ® | 5000 | 0 | 25 | 4.6 | 11.72 | 0.07 | 0.53 | 0.69 |
| 480 L | | | | | | | | |
| SEQ ID | 500 | 100 | 60 | 8.1 | 11.73 | 0.09 | 1.35 | 1.54 |
| NO: 1 | | | | | | | | |
| SEQ ID | 1000 | 100 | 60 | 3.6 | 11.79 | 0.26 | 2.52 | 2.90 |
| NO: 1 | | | | | | | | |
| SEQ ID | 2000 | 100 | 60 | 2.6 | 11.89 | 0.72 | 3.46 | 4.25 |
| NO: 1 | | | | | | | | |
| SEQ ID | 890 | 100 | 40 | 5.7 | 11.92 | 0.08 | 0.99 | 1.17 |
| NO: 1 | | | | | | | | |
| SEQ ID | 1810 | 100 | 40 | 3.5 | 12.00 | 0.17 | 1.96 | 2.22 |
| NO: 1 | | | | | | | | |
| SEQ ID | 3590 | 100 | 40 | 3.4 | 12.05 | 0.46 | 3.65 | 4.20 |
| NO: 1 | | | | | | | | |
| SEQ ID | 1400 | 100 | 25 | 3.6 | 12.02 | 0.18 | 2.41 | 2.69 |
| NO: 1 | | | | | | | | |
| SEQ ID | 2900 | 100 | 25 | 3.1 | 11.94 | 0.21 | 2.55 | 2.86 |
| NO: 1 | | | | | | | | |
| SEQ ID | 5700 | 100 | 25 | 3.1 | 11.97 | 0.28 | 2.65 | 3.04 |
| NO: 1 | | | | | | | | |

Table 3 shows that the samples comprising the raw starch amylase encoded by SEQ ID NO: 1 produce a oat hydrolysate higher in total sugars compared to the samples comprising BAN® 480 L and Fungamyl® 800 L performed at a temperature between 25-60° C.

### Example 4: Preparation of a Rice Hydrolysate Using the Raw Starch Degrading Alpha-Amylase of SEQ ID NO: 1

Rice flour was mixed with water comprising enzyme in a ratio of 100 g rice flour to 600 g of water. Assays were performed using the amylase encoded by SEQ ID NO: 1 and a beta-glucanase (Ultraflo® Prime, Novozymes A/S, Denmark), or a standard method which comprises two different amylases, namely BAN® 480 L (Novozymes A/S, Denmark), supplied at the dosages stated in Tables 5 and 6, and also Fungamyl® 800 L (Novozymes A/S, Denmark), supplied at 1500 ppm for all samples comprising BAN® 480 L. The mixture of water, enzyme and oat flour was then heated to 25° C., 40° C., or 60° C. for 30 minutes to allow for liquefaction/hydrolysis, followed by inactivation of the enzymes by increasing the temperature to 95° C. for 15 minutes. After inactivation, the hydrolysates were cooled to 60° C. for centrifugation and centrifuged at 3000 RPM for 10 minutes to separate the solid and liquid phases. The liquid phase was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Table 4. Table 4 provides the viscosity, total solids, and sugar content of the rice hydrolysate. Amylase and beta glucanase amounts are provided in ppm on flour basis.

TABLE 4
Viscosity and Released Sugars in Rice Hydrolysate

| | | Beta | Hydrolysis | | Total | | | Total |
|---|---|---|---|---|---|---|---|---|
| | Amylase | glucanase | temperature | | solids | Glucose | Maltose | sugars |
| Amylase | (ppm) | (ppm) | (° C.) | Viscosity | (%) | (g/100 g) | (g/100 g) | (g/100 g) |
| | 0 | 0 | 60 | 1.5 | 1.8 | 0.09 | 0.00 | 0.22 |
| | 0 | 0 | 40 | 1.2 | 0.9 | 0.04 | 0.02 | 0.18 |
| | 0 | 0 | 25 | 1.1 | 0.6 | 0.03 | 0.06 | 0.22 |
| BAN ® 480 L | 2000 | 0 | 60 | 10.7 | 11.7 | 0.46 | 0.91 | 1.50 |
| BAN ® 480 L | 2500 | 0 | 40 | 4.6 | 11.8 | 0.17 | 0.76 | 1.05 |
| BAN ® 480 L | 5000 | 0 | 25 | 3.2 | 11.7 | 0.08 | 0.44 | 0.61 |
| SEQ ID NO: 1 | 500 | 100 | 60 | 4.6 | 12.0 | 0.56 | 0.97 | 1.67 |
| SEQ ID NO: 1 | 1000 | 100 | 60 | 2.1 | 12.1 | 0.94 | 2.32 | 3.42 |
| SEQ ID NO: 1 | 2000 | 100 | 60 | 1.8 | 12.4 | 1.47 | 3.50 | 5.13 |
| SEQ ID NO: 1 | 890 | 100 | 40 | 3.6 | 12.0 | 0.18 | 0.89 | 1.16 |
| SEQ ID NO: 1 | 1810 | 100 | 40 | 2.2 | 12.1 | 0.30 | 2.11 | 2.52 |
| SEQ ID NO: 1 | 3590 | 100 | 40 | 2.0 | 12.4 | 0.54 | 2.96 | 3.60 |
| SEQ ID NO: 1 | 1400 | 100 | 25 | 2.7 | 12.4 | 0.17 | 1.39 | 1.66 |
| SEQ ID NO: 1 | 2900 | 100 | 25 | 2.0 | 12.3 | 0.30 | 2.85 | 3.26 |
| SEQ ID NO: 1 | 5700 | 100 | 25 | 1.9 | 12.3 | 0.70 | 4.11 | 4.92 |

The data in Table 4 show that the samples comprising the raw starch amylase encoded by SEQ ID NO: 1 produce a rice hydrolysate higher in total sugars compared to the samples comprising BAN® 480 L and Fungamyl® 800 L performed at a temperature between 25-60° C.

### Example 5: Preparation of a Pea Hydrolysate Using the Raw Starch Degrading Alpha-Amylase of SEQ ID NO: 1

Pea flour was mixed with water comprising enzyme in a ratio of 100 g flour to 600 g of water. Assays were performed using the amylase encoded by SEQ ID NO: 1 and a beta-glucanase (Ultraflo® Prime, Novozymes A/S, Denmark), or a standard method which comprises two different amylases, namely BAN® 480 L (Novozymes A/S, Denmark), supplied at the dosages stated in Tables 7 and 8, and also Fungamyl® 800 L (Novozymes A/S, Denmark), supplied at 1500 ppm for all samples comprising BAN® 480 L. The mixture of water, enzyme and oat flour was then heated to 25° C., 40° C., or 60° C. for 30 minutes to allow for liquefaction/hydrolysis, followed by inactivation of the enzymes by increasing the temperature to 95° C. for 15 minutes. After inactivation, the hydrolysates were cooled to 60° C. for centrifugation and centrifuged at a Relative Centrifugal Force of 1932×g using a Multifuge® 3 S-R (Kendro Heraeus) to separate the solid and liquid phases. The liquid phase was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Table 5. Table 5 provides the viscosity, total solids, and sugar content of the rice hydrolysate. Amylase and beta glucanase amounts are provided in ppm on flour basis.

TABLE 5
Viscosity and Released Sugars in Pea Hydrolysate

| | | Beta | Hydrolysis | | Total | | | Total |
|---|---|---|---|---|---|---|---|---|
| | Amylase | glucanase | temperature | | solids | Glucose | Maltose | sugars |
| Amylase | (ppm) | (ppm) | (° C.) | Viscosity | (%) | (g/100 g) | (g/100 g) | (g/100 g) |
| | 0 | 0 | 60 | 172.6 | 5.34 | 0.106 | 0.171 | 0.86 |
| | 0 | 0 | 40 | 2.2 | 4.07 | 0.130 | 0.154 | 0.83 |
| | 0 | 0 | 25 | 2.0 | 4.32 | 0.082 | 0.078 | 0.67 |
| BAN ® 480 L | 2000 | 0 | 60 | 3.7 | 10.80 | 0.174 | 1.249 | 1.96 |
| BAN ® 480 L | 2500 | 0 | 40 | 4.0 | 10.15 | 0.134 | 0.283 | 0.91 |
| BAN ® 480 L | 5000 | 0 | 25 | 7.0 | 10.83 | 0.131 | 0.433 | 1.04 |
| SEQ ID NO: 1 | 500 | 100 | 60 | 8.2 | 10.86 | 0.222 | 0.812 | 1.56 |
| SEQ ID NO: 1 | 1000 | 100 | 60 | 3.4 | 10.86 | 0.682 | 0.988 | 2.24 |
| SEQ ID NO: 1 | 2000 | 100 | 60 | 3.2 | 10.73 | 0.887 | 0.794 | 2.22 |
| SEQ ID NO: 1 | 890 | 100 | 40 | 5.1 | 11.11 | 0.169 | 0.872 | 1.54 |
| SEQ ID NO: 1 | 1810 | 100 | 40 | 4.6 | 11.17 | 0.431 | 0.930 | 1.87 |
| SEQ ID NO: 1 | 3590 | 100 | 40 | 3.4 | 10.82 | 0.801 | 0.713 | 2.05 |
| SEQ ID NO: 1 | 1400 | 100 | 25 | 5.1 | 10.96 | 0.328 | 0.949 | 1.77 |
| SEQ ID NO: 1 | 2900 | 100 | 25 | 4.1 | 11.05 | 0.653 | 0.631 | 1.75 |
| SEQ ID NO: 1 | 5700 | 100 | 25 | 3.7 | 11.01 | 0.961 | 0.393 | 1.78 |

The data in Table 5 show that the samples comprising the raw starch amylase encoded by SEQ ID NO: 1 produce a pea hydrolysate higher in total sugars compared to the samples comprising BAN® 480 L and Fungamyl® 800 L performed at a temperature between 25-60° C.

### Example 6: Preparation of an Oat Hydrolysate Using the Raw Starch Degrading Alpha-Amylase of SEQ ID NO: 3 or SEQ ID NO: 4

For each assay, oat flour was mixed with water comprising enzyme in a ratio of 100 g flour to 600 g of water. Assays were performed using either the amylase encoded by SEQ ID NO: 3 or SEQ ID NO: 4, and also a beta-glucanase (Ultraflo® Prime, Novozymes A/S, Denmark). A standard assay which comprises two different amylases, namely BAN® 480 L (Novozymes A/S, Denmark), supplied at the dosages stated in the tables below, and also Fungamyl® 800 L (Novozymes A/S, Denmark), supplied at 1500 ppm for all samples comprising BAN® 480 L, was also performed. The mixture of water, enzyme and oat flour was then heated to 25° C., 40° C., or 60° C. for 30 minutes to allow for liquefaction/hydrolysis, followed by inactivation of the enzymes by increasing the temperature to 95° C. for 15 minutes. After inactivation, the hydrolysates were cooled to 60° C. for centrifugation and centrifuged at a Relative Centrifugal Force of 1932×g using a Multifuge® 3 S-R (Kendro Heraeus) to separate the solid and liquid phases. The liquid phase was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Tables 6 and 7 below. Tables 6 and 7 provide the viscosity, total solids, and sugar content of the oat hydrolysate from assays performed with either SEQ ID NO: 3 or SEQ ID NO: 4. Amylase and beta glucanase amounts are provided in ppm on flour basis.

TABLE 6
Viscosity and Released Sugars in Oat Hydrolysate from Assays Performed with SEQ ID NO: 3

| | | Beta | Hydrolysis | | Total | | | Total |
|---|---|---|---|---|---|---|---|---|
| | Amylase | glucanase | temperature | | solids | Glucose | Maltose | sugars |
| Amylase | (ppm) | (ppm) | (° C.) | Viscosity | (%) | (g/100 g) | (g/100 g) | (g/100 g) |
| | 0 | 0 | 60 | 3.1 | 0.78 | 0.00 | 0.01 | 0.36 |
| | 0 | 0 | 40 | 1.3 | 0.46 | 0.00 | 0.00 | 0.38 |
| | 0 | 0 | 25 | 1.2 | 0.41 | 0.01 | 0.00 | 0.37 |
| BAN ® 480 L | 2000 | 0 | 60 | 2.9 | 12.14 | 0.17 | 2.65 | 2.93 |
| BAN ® 480 L | 2500 | 0 | 40 | 4.0 | 11.63 | 0.05 | 0.44 | 0.59 |
| BAN ® 480 L | 5000 | 0 | 25 | 4.6 | 11.72 | 0.07 | 0.53 | 0.69 |
| SEQ ID NO: 3 | 48300 | 100 | 60 | 3.2 | 12.57 | 0.65 | 1.28 | 2.09 |
| SEQ ID NO: 3 | 87300 | 100 | 40 | 5.0 | 12.38 | 0.59 | 1.27 | 2.03 |
| SEQ ID NO: 3 | 139900 | 100 | 25 | 9.9 | 12.54 | 0.77 | 1.53 | 2.48 |

TABLE 7
Viscosity and Released Sugars in Oat Hydrolysate from Assays Performed with SEQ ID NO: 4

| | | Beta | Hydrolysis | | Total | | | Total |
|---|---|---|---|---|---|---|---|---|
| | Amylase | glucanase | temperature | | solids | Glucose | Maltose | sugars |
| Amylase | (ppm) | (ppm) | (° C.) | Viscosity | (%) | (g/100 g) | (g/100 g) | (g/100 g) |
| | 0 | 0 | 60 | 3.1 | 0.78 | 0.00 | 0.01 | 0.36 |
| | 0 | 0 | 40 | 1.3 | 0.46 | 0.00 | 0.00 | 0.38 |
| | 0 | 0 | 25 | 1.2 | 0.41 | 0.01 | 0.00 | 0.37 |
| BAN ® 480 L | 2000 | 0 | 60 | 2.9 | 12.14 | 0.17 | 2.65 | 2.93 |
| BAN ® 480 L | 2500 | 0 | 40 | 4.0 | 11.63 | 0.05 | 0.44 | 0.59 |
| BAN ® 480 L | 5000 | 0 | 25 | 4.6 | 11.72 | 0.07 | 0.53 | 0.69 |
| SEQ ID NO: 4 | 2400 | 100 | 60 | 7.4 | 13.39 | 0.17 | 0.95 | 1.23 |
| SEQ ID NO: 4 | 4400 | 100 | 40 | 7.3 | 11.98 | 0.17 | 0.57 | 0.87 |
| SEQ ID NO: 4 | 7000 | 100 | 25 | 10.6 | 11.16 | 0.12 | 0.41 | 0.66 |

The results shown in Tables 6 and 7 indicate that a raw starch degraded amylase produces an oat hydrolysate with desirable viscosity, total solids, and total sugars when hydrolysis is performed at a temperature between 25-60° C.

### Example 7: Industrial Trials Using the Amylase of SEQ ID NO: 1

5700 ppm (on oat flour basis) of the amylase SEQ ID NO: 1 was added to 1600 L of water together with 100 ppm beta-glucanase (Ultraflo® Prime, Novozymes A/S, Denmark) and mixed with 400 Kg oat flour. The slurry was heated up to various temperatures and for various minutes to allow for hydrolysis, as shown in the tables below.

Following hydrolysis, the hydrolysed slurry went through an inactivation step of 85° C. for 15 seconds and then was processed in a decanter. The separated liquid stream was then cooled to 10° C. The liquid stream is a plant-based food ingredient, now also referred to as a oat concentrate base.

The oat concentrate base was diluted with water and salt (0.08% w/w) and rapeseed oil (0.8% w/w) were added. The resulting oat beverage was UHT treated using methods known in the art and aseptically packed. The oat beverage was analyzed for viscosity using the Anton Paar MCR-302 (Anton Paar GmbH, Austria) with the CC27 conical cone measurement system. Released sugars were measured using High Performance Anion Exchange chromatography using Pulsed amperometry detection (HPAE-PAD). Results are shown in Tables 8. Table 8 provides the viscosity, total solids, and sugar content of the oat beverage.

TABLE 8
Viscosity and Released Sugars in Oat Beverage

| | | Beta | Hydrolysis | | | Total | | | Total |
|---|---|---|---|---|---|---|---|---|---|
| | Amylase | glucanase | temperature | Hydrolysis | | solids | Glucose | Maltose | sugars |
| Amylase | (ppm) | (ppm) | (° C.) | time (min) | Viscosity | (%) | (g/100 g) | (g/100 g) | (g/100 g) |
| SEQ ID | 5700 | 100 | 25 | 90 | 4.63 | 12.24 | 1.60 | 4.07 | 5.85 |
| NO: 1 | | | | | | | | | |
| SEQ ID | 3000 | 100 | 50 | 60 | 4.09 | 12.35 | 0.98 | 3.16 | 4.31 |
| NO: 1 | | | | | | | | | |
| SEQ ID | 2000 | 100 | 60 | 60 | 3.29 | 13.03 | 2.04 | 4.13 | 6.38 |
| NO: 1 | | | | | | | | | |

These results indicate that an incubation temperature between 25-60° C. is sufficient to produce a desirable oat beverage at an industrial scale when using a raw starch amylase.

### Example 8: Preparation of an Oat Hydrolysate Using the Raw Starch Degrading Alpha-Amylase Of SEQ ID NO: 1 and 0-100 ppm Beta-Glucanase

45 g oat flour and 255 g deionized water were directly weighed into 500 mL flasks. Enzymes were added according to the experimental design shown in Table 9. Ultraflo® Prime was used to provide the beta-glucanase.

TABLE 9
Experimental Design

| No | Enzyme | Dose | |
|---|---|---|---|
| 1 | BAN ® 480 L | 2000 | ppm |
| | Fungamyl 800 L | 2000 | ppm |
| 2 | SEQ ID NO: 1 | 1000 | ppm |
| | Beta-glucanase | 100 | ppm |
| 3 | SEQ ID NO: 1 | 1000 | ppm |
| | Beta-glucanase | 50 | ppm |
| 4 | SEQ ID NO: 1 | 1000 | ppm |
| | Beta-glucanase | 40 | ppm |
| 5 | SEQ ID NO: 1 | 1000 | ppm |
| | Beta-glucanase | 0 | ppm |

The suspension was heated to 60° C. Once the target temperature of 60° was reached, the reaction mixture was stirred at 300 rpm or 120 min. To terminate the enzyme action, the suspension was heated to 90° C. and held at 90° C. for 10 min. Without cooling, the hot suspension was separated into a liquid base material and a solid pellet fraction by centrifugation at 3×1200 g. After separation, the oat base was weighed and placed in an ice bath.

The samples were equilibrated to room temperature and sunflower oil and sodium chloride were added to a final concentration of 1% and 0.08%, respectively, to formulate an oat beverage. The samples were then homogenized using a Thermomix® TM6® (Vorwerk, Wuppertal, Germany). The oat beverage was then analysed for viscosity using a Hamilton Microlab® STAR™ Liquid Handler (Hamilton Robotics Inc./Hamilton Bonaduz AG) and methods similar to those in WO 2011/107472 (herein incorporated by reference in its entirety). Viscosity data have been multiplied with −1 to arrive at a positive value; a higher value correlates to a higher viscosity. The amount of beta-glucan in the samples was quantified according to Application Note 64538 (Thermo Scientific, Waltham, MA, United States) and measured on a Gallery™ Plus Beermaster Discrete Analyzer (Thermo Scientific). Table 10 provides the viscosity and amounts of beta-glucan in the oat beverages.

TABLE 10
Viscosity and beta-glucan in Oat Beverage

| | | | | Beta-glucan | ViPr, |
|---|---|---|---|---|---|
| No | Enzyme | Dose | | (g/L) | Viscosity |
| 1 | BAN ® 480 L | 2000 | ppm | 0 | 407.2 |
| | Fungamyl 800 L | 2000 | ppm | | |
| 2 | SEQ ID NO: 1 | 1000 | ppm | 0.39 | 442.1 |
| | Beta-glucanase | 100 | ppm | | |
| 3 | SEQ ID NO: 1 | 1000 | ppm | 0.63 | 438.9 |
| | Beta-glucanase | 50 | ppm | | |
| 4 | SEQ ID NO: 1 | 1000 | ppm | 0.74 | 452.0 |
| | Beta-glucanase | 40 | ppm | | |
| 5 | SEQ ID NO: 1 | 1000 | ppm | 2.93 | 681.6 |
| | Beta-glucanase | 0 | ppm | | |

Sample No. 1 has a lower viscosity in the final oat beverage compared to Sample No. 5. However, viscosity similar to that in Sample No. 1 is achieved in Sample Nos. 2-4, without fully degrading or hydrolyzing the beta-glucans. No beta-glucan can be detected Sample No. 1.

1. A method for obtaining a plant-based food ingredient for a dairy alternative food product, comprising:
(a) obtaining a slurry of plant material in water; and
(b) providing a raw starch degrading alpha-amylase and optionally additional enzyme(s) to the slurry of step (a) and holding at a temperature between 25-60° C. to obtain a hydrolyzed plant material;
wherein the hydrolyzed plant material is a plant-based food ingredient for a dairy alternative food product.

2. The method of claim 1, further comprising
(c) separating the hydrolyzed plant material into solid and liquid streams;
(d) harvesting the liquid stream as a plant-based food ingredient for a dairy alternative food product; and
(e) optionally inactivating the enzyme(s) before or after step (c) or (d).

3. The method of claim 1, wherein the raw starch degrading alpha-amylase is a GH13 family amylase that comprises a carbohydrate binding module (CBM) which binds preferentially to starch.

4. The method of claim 1, wherein the raw starch degrading alpha-amylase comprises an amino acid sequence at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% identical to SEQ ID NO: 1, 2, 3, or 4.

5. The method of claim 1, wherein the additional enzyme is a glucoamylase, maltogenic amylase, beta-amylase, protease, hemicellulase, cellulase, pectolytic enzyme, glucosidase, glucanase, xylanase, arabinofuranosidase, pullulanase, and/or lipase, or any combination thereof.

6. The method of claim 1, wherein the additional enzyme is a beta-glucanase.

7. The method of claim 1, wherein the temperature of step (b) is between 25-55° C., 30-55° C., 35-55° C., 40-60° C., 30-50° C., or 40-55° C.

8. The method of claim 1, wherein the plant material is derived from corn, rice, barley, wheat, quinoa, oat, rye, flax, hemp, buckwheat, milo, millet, sago, cassava, tap-ioca, potatoes, sweet potatoes, peas, beans, cashew, macadamia, sesame, coconut, banana, jack fruit, and/or bread fruit.

9. The method of claim 1, wherein the plant material is a cereal flour or de-hulled grains, including corn flour, rice flour, barley flour, buckwheat flour, wheat flour, millet flour, quinoa flour, oat flour, rye flour, or a mixture thereof.

10. The method of claim 1, wherein the plant material is oat flour, oat flakes, oat bran, groats, or any combination thereof.

11. The method of claim 1, wherein the dairy alternative food product is a plant-based beverage, plant-based ice cream, plant-based creamer, plant-based yogurt, or plant-based cheese.

12. (canceled)

13. A method for obtaining an oat hydrolysate food ingredient for a dairy alternative food product, comprising
(a) obtaining a slurry of oat material in water;
(b) providing a raw starch degrading alpha-amylase and a beta-glucanase to the slurry of step (a) and holding at a temperature between 25-60° C., 25-55° C., 45-55° C., or 50-55° C. to obtain an oat hydrolysate;
(c) separating the oat hydrolysate into solid and liquid streams;
(d) harvesting the liquid stream; and
(e) optionally inactivating the enzymes before or after step (c) or (d);
wherein the harvested liquid stream is an oat hydrolysate food ingredient for a dairy alter-native food product.

14. The method of claim 13, wherein the raw starch degrading alpha-amylase is a GH13 family amylase that comprises a carbohydrate binding module (CBM) which binds preferentially to starch.

15. The method of claim 13, wherein the raw starch degrading alpha-amylase comprises an amino acid sequence at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% identical to SEQ ID NO: 1, 2, 3, or 4.

16. The method of claim 1, wherein the raw starch degrading alpha-amylase is a GH13 family amylase that comprises a carbohydrate binding module (CBM) which binds preferentially to starch, wherein the CBM is CBM20, 21, 25, 26, 34, 41, 45, 48, 53, 68, 69, 74, 82, or 83.

17. The method of claim 1, wherein the raw starch degrading alpha-amylase comprises an amino acid sequence at least 90% identical to SEQ ID NO: 1, 2, 3, or 4.


SEQUENCE LISTING (5 sequences)

SEQ ID NO: 1 - protein, 580 aa, Synthetic construct
DDWKGKAIYQLLTDRFGRADDSTSNCSNLSNYCGGTYEGITKHLDYISGMGFDAIWISPIPKNSDGGYHGYWATDFYQLNSNFGDESQLKALIQAAHERDMYVMLDVVANHAGPTSNGYSGYTFDDASLYHPKCTIDYNNQTSIEQCWVADELPDIDTENSDNVAILNDIVSGWVGNYSFDGIRIDTVKHIRKDFWTGYAEAAGVFATGEVFNGDPAYVGPYQKYLPSLINYPMYYALNDVFVSKSKGFSRISEMLGSNRNAFEDTSVLTTFVDNHDNPRFLNSQSDKALFKNALTYVLLGEGIPIVYYGSEQGFSGGADPANREVLWTTNYDTSSDLYQFIKTVNSVRMKSNKAVYMDIYVGDNAYAFKHGDALVVLNNYGSGSTNQVSFSVSGKFDSGASLMDIVSNITTTVSSDGTVTFNLKDGLPAIFTSATGGTTTTATPTGSGSVTSTSKTTATASKTSTSTSSTSCTTPTAVAVTFDLTATTTYGENIYLVGSISQLGDWETSDGIALSADKYTSSDPLWYVTVTLPAGESFEYKFIRIESDDSVEWESDPNREYTVPQACGTSTATVTDTWR

SEQ ID NO: 2 - protein, 583 aa, Synthetic construct
ATSDDWKGKAIYQLLTDRFGRADDSTSNCSNLSNYCGGTYEGITKHLDYISGMGFDAIWISPIPKNSDGGYHGYWATDFYQLNSNFGDESQLKALIQAAHERDMYVMLDVVANHAGPTSNGYSGYTFGDASLYHPKCTIDYNDQTSIEQCWVADELPDIDTENSDNVAILNDIVSGWVGNYSFDGIRIDTVKHIRKDFWTGYAEAAGVFATGEVFNGDPAYVGPYQKYLPSLINYPMYYALNDVFVSKSKGFSRISEMLGSNRNAFEDTSVLTTFVDNHDNPRFLNSQSDKALFKNALTYVLLGEGIPIVYYGSEQGFSGGADPANREVLWTTNYDTSSDLYQFIKTVNSVRMKSNKAVYMDIYVGDNAYAFKHGDALVVLNNYGSGSTNQVSFSVSGKFDSGASLMDIVSNITTTVSSDGTVTFNLKDGLPAIFTSATGGTTTTATPTGSGSVTSTSKTTATASKTSTSTSSTSCTTPTAVAVTFDLTATTTYGENIYLVGSISQLGDWETSDGIALSADKYTSSDPLWYVTVTLPAGESFEYKFIRIESDDSVEWESDPNREYTVPQACGTSTATVTDTWR

SEQ ID NO: 3 - protein, 586 aa, Synthetic construct
GSVPVNGTMMQYFEWYLPDDGTLWTKVANNAQSLANLGITALWLPPAYKGTSSSDVGYGVYDLYDLGEFNQKGTVRTKYGTKTQYIQAIQAAHTAGMQVYADVVFNHKAGADGTELVDAVEVNPSDRNQEISGTYQIQAWTKFDFPGRGNTYSSFKWRWYHFDGTDWDESRKLNRIYKFRGTGKAWDWEVDTENGNYDYLMYADLDMDHPEVVSELKNWGKWYVTTTNIDGFRLDAVKHIKYSFFPDWLSYVRTQTQKPLFAVGEFWSYDISKLHNYITKTNGSMSLFDAPLHNNFYIASKSGGYFDMRTLLNNTLMKDQPTLAVTLVDNHDTEPGQSLQSWVEPWFKPLAYAFILTRQEGYPCVFYGDYYGIPKYNIPALKSKLDPLLIARRDYAYGTQHDYIDSADIIGWTREGVAEKANSGLAALITDGPGGSKWMYVGKQHAGKTFYDLTGNRSDTVTINADGWGEFKVNGGSVSIWVPKISTTSQITFTVNNATTVWGQNVYVVGNISQLGNWDPVHAVQMTPSSYPTWTVTIPLLQGQNIQFKFIKKDSAGNVIWEDISNRTYTVPTAASGAYTASWNVP

SEQ ID NO: 4 - protein, 615 aa, Synthetic construct
SSVKNGTILHAWNWSFNTLTQNMKDIRDAGYAAIQTSPINQVKEGNQGDKSMRNWYWLYQPTSYQIGNRYLGTEQEFKDMCAAAKKYGVKVIVDAVINHTTSDYGAISDEIKRIPNWTHGNTQIKNWSDRWDVTQNSLLGLYDWNTQNTEVQAYLKRFLERALNDGASGFRYDAAKHIELPDDGWYGGQFWPNITNTSAEFQYGEILQDSVSRDTAYANYMNVTASNYGHSIRSALKNRNLSVSNISHYASDVSADKLVTWVESHDTYANDDQESTWMSDDDIRLGWAVIGSRSGSTPLFFSRPEGGGNGVRFPGKSQIGDRGSALFKDQAITAVNTFHNVMAGQPEELSNPNGNNQIFMNQRGSKGVVLANAGSSSVTINTSAKLPDGRYDNRAGAGSFQVANGKLTGTINARSAAVLYPDDIGNAPHVFLENYQTGAVHSFNDQLTVTLRANAKTTKAVYQINNGQQTAFKDGDRLTIGKGDPIGTTYNIKLTGTNGEGAARTQEYKFVKKDPSQTNIIGYQNPDHWGQVNAYIYKHDGGRAIELTGSWPGKAMTKNADGMYTLTLPENADTANAKVIFNNGSAQVPGQNQPGFDYVQNGLYNNSGLNGYLPH

SEQ ID NO: 5 - protein, 327 aa, Synthetic construct
GVRFAGVNIAGFDFGCTTDGTCDTSKIYPPLKNFTGSNNYPDGIGQMQHFVNDDGMNIFRLPVGWQYLVNNNLGGNLDSTSISKYDQLVQGCLSLGAYCIIDIHNYARWNGGIIGQGGPTNAQFTSLWSQLASKYASQSRVWFGIMNEPHDVNINTWAATVQEVVTAIRNAGATSHFISLPGNDWQSAGAFISDGSAAALSQVTNPDGSTTNLIFDVHKYLDSDNSGTHAECTTNNIDGAFSPLATWLRQNNRQAILTETGGGNVESCIQNMCQQIQYLNQNSDVYLGYVGWAAGSFDSTYVLTETPTCSGNSWTDTSLVSSCLARK